(19) United States
(12) Patent Application Publication
(10) Pub. No.: US 2026/0046508 A1
(43) Pub. Date: Feb. 12, 2026

(54) Facial Region of Interest Expansion for Luma-Based Exposure Determination

(71) Applicant: Google LLC, Mountain View, CA (US)

(72) Inventors: Madeleine Joyce Yip, San Francisco, CA (US); Alex William Greer, Redwood City, CA (US); Lin Lu, Taichung (TW); Hsing Ju Hung, New Taipei City (CN); Ariel Chiati Yin, San Diego, CA (US)

(21) Appl. No.: 18/800,337

(22) Filed: Aug. 12, 2024

(51) Int. Cl. H04N 23/611; G06V 10/25; G06V 10/70; G06V 40/16; H04N 23/71; H04N 23/73

(52) U.S. Cl. CPC H04N 23/611; G06V 10/25; G06V 10/70; G06V 40/162; G06V 40/171; H04N 23/71; H04N 23/73

(57) ABSTRACT

A method of determining a facial luma includes generating, based on image data, facial landmark data and facial region of interest data using the one or more machine learning models. The facial landmark data is indicative of facial landmarks of a face in the scene, and the facial region of interest data is indicative of an initial region of interest of the face. The method includes generating an adjusted region of interest of the face by expanding the initial region of interest. The method also includes determining an exposure of an image of the scene based on the adjusted region of interest.

### BACKGROUND

Devices may be used to capture images and videos. For example, a device may include one or more cameras (e.g., image sensors) to capture images and videos of people. When capturing an image or video of a person, exposure parameters for the person's face may be prioritized by (i) calculating the luma for the facial region and (ii) adjusting the exposure parameters based on an average luma value across the facial region.

Typically, a small region of interest is used to calculate the luma for the facial region. For example, the region of interest may be a box that spans from the mouth to the eyes. However, in some scenarios where overhead lighting is relatively strong (e.g., bright), the luma calculated using the region of interest may result in exposure parameters that create unrealistic skin tones of unappealing skin texture.

### SUMMARY

A device can generate an initial region of interest for calculating a facial luma that is used to generate exposure parameters during an image capture. Because the initial region of interest is based on a region between the eyes and the mouth of the face, to prevent scenarios where the exposure parameters create unrealistic skin tones due to overhead lighting, the device may expand the initial region of interest to include the forehead region. To expand the initial region of interest, the device may identify a major forehead axis along the mouth and the nose. Using a segmentation mask that distinguishes skin areas from non-skin areas, the device may search for a first point along the major forehead axis that corresponds to a top of the forehead and may extend the initial region of interest to include the first point. To search for points along the side of the forehead, the device may (i) identify additional axes along the mouth and each eye and (ii) search for points along the additional axes that correspond to the sides of the forehead. The device may further extend the initial region of interest to include the additional points.

After the initial region of interest has been extended to include the forehead, the segmentation mask may be used to identify segments within the region of interest that correspond to skin (as opposed to non-skin). The skin segments may be used to calculate the facial luma, which in turn, may be used to adjust the exposure parameters during image capture.

In a first example embodiment, a method includes providing, by a processor to one or more machine learning models, image data associated with a scene to be captured. The method also includes generating, by the processor and based on the image data, facial landmark data and facial region of interest data using the one or more machine learning models. The facial landmark data is indicative of facial landmarks of a face in the scene, and the facial region of interest data is indicative of an initial region of interest of the face. The method also includes generating, by the processor, an adjusted region of interest of the face by expanding the initial region of interest. The method also includes determining, by the processor, an exposure of an image of the scene based on the adjusted region of interest.

In a second example embodiment, a device includes a memory and a processor coupled to the memory. The processor is configured to provide, to one or more machine learning models, image data associated with a scene to be captured. The processor is also configured to generate, based on the image data, facial landmark data and facial region of interest data using the one or more machine learning models. The facial landmark data is indicative of facial landmarks of a face in the scene, and the facial region of interest data is indicative of an initial region of interest of the face. The processor is also configured to generate an adjusted region of interest of the face by expanding the initial region of interest. The processor is also configured to determine an exposure of an image of the scene based on the adjusted region of interest.

In a third example embodiment, a non-transitory computer-readable medium includes instructions that, when executed by a processor, cause the processor to perform operations. The operations include providing, to one or more machine learning models, image data associated with a scene to be captured. The operations also include generating, based on the image data, facial landmark data and facial region of interest data using the one or more machine learning models. The facial landmark data is indicative of facial landmarks of a face in the scene, and the facial region of interest data is indicative of an initial region of interest of the face. The operations also include generating an adjusted region of interest of the face by expanding the initial region of interest. The operations also include determining an exposure of an image of the scene based on the adjusted region of interest.

In a fourth example embodiment, a computer program product includes a computer hardware storage device having stored therein computer-executable program code for adjusting a facial region of interest. The computer-executable program code, when executed by a computer, causes the computer to provide, to one or more machine learning models, image data associated with a scene to be captured. The computer-executable program code, when executed by the computer, further causes the computer to generate, based on the image data, facial landmark data and facial region of interest data using the one or more machine learning models. The facial landmark data is indicative of facial landmarks of a face in the scene, and the facial region of interest data is indicative of an initial region of interest of the face. The computer-executable program code, when executed by the computer, further causes the computer to generate an adjusted region of interest of the face by expanding the initial region of interest. The computer-executable program code, when executed by the computer, further causes the computer to determine an exposure of an image of the scene based on the adjusted region of interest.

In a fifth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A illustrates a scene to be captured by a sensor, in accordance with examples described herein.

FIG. 1B illustrates process steps for adjusting a facial region of interest to accurately calculate a facial luma, in accordance with examples described herein.

FIG. 1C illustrates additional process steps for adjusting a facial region of interest to accurately calculate a facial luma, in accordance with examples described herein.

FIG. 1D illustrates additional process steps for adjusting a facial region of interest to accurately calculate a facial luma, in accordance with examples described herein.

FIG. 1E illustrates additional process steps for adjusting a facial region of interest to accurately calculate a facial luma, in accordance with examples described herein.

FIG. 1F illustrates additional process steps for adjusting a facial region of interest to accurately calculate a facial luma, in accordance with examples described herein.

FIG. 1G illustrates additional process steps for adjusting a facial region of interest to accurately calculate a facial luma, in accordance with examples described herein.

FIG. 1H illustrates process steps for adjusting a facial region of interest to accurately calculate a facial luma, in accordance with examples described herein.

FIG. 2 illustrates a device, in accordance with examples described herein.

FIG. 3 illustrates an example of a process of adjusting a region of interest, in accordance with examples described herein.

FIG. 4 is a diagram illustrating training and inference phases of a machine learning model, in accordance with examples described herein.

FIG. 5 illustrates a flow chart, in accordance with examples described herein.

FIG. 6 illustrates another flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

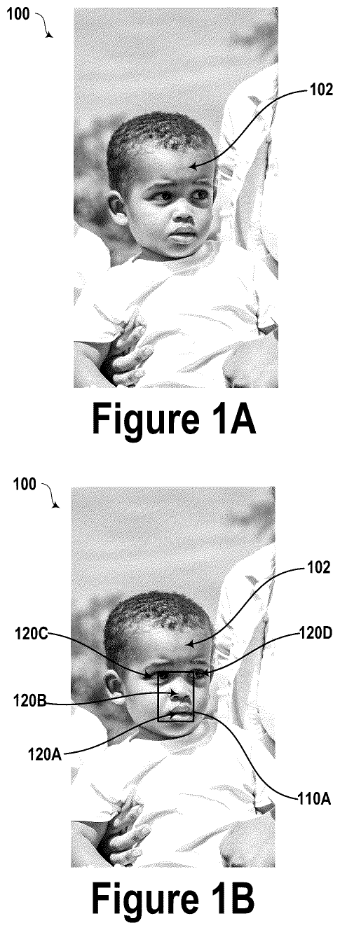

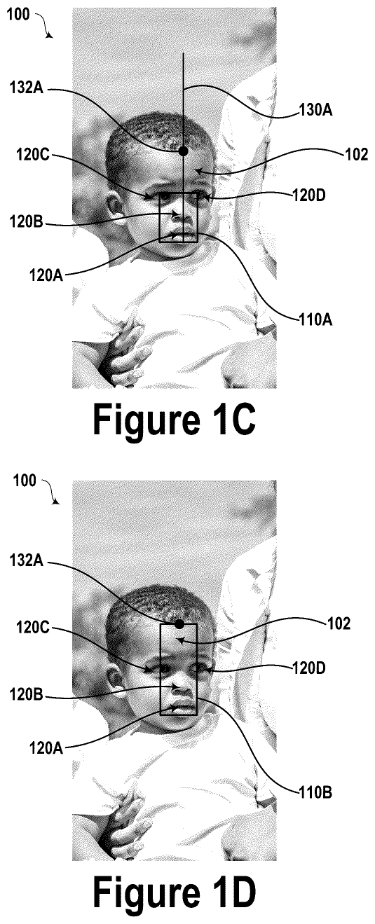

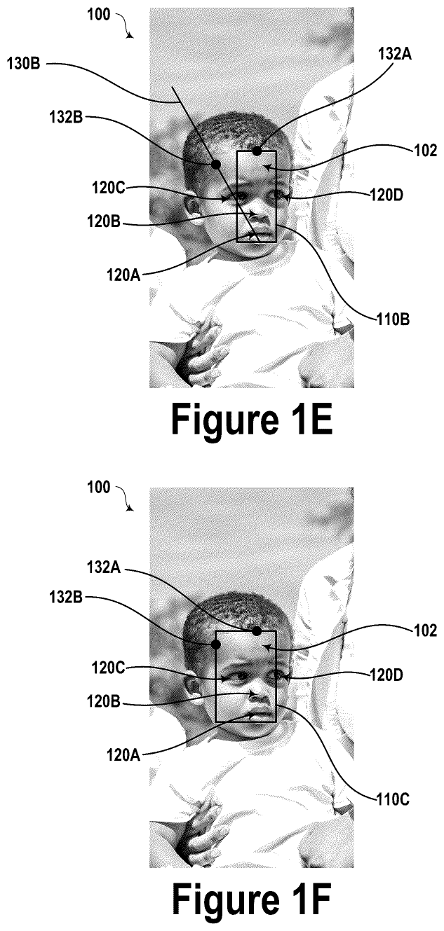

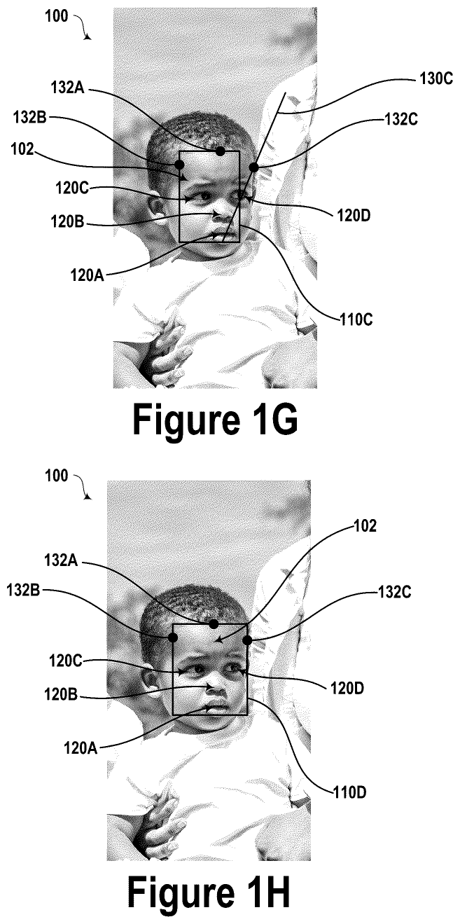

Particular embodiments are described herein with reference to the drawings. In the description, common features are designated by common reference numbers throughout the drawings. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1B, facial landmarks are illustrated and associated with reference numbers 120A, 120B, 120C, and 120D. When referring to a particular facial landmark, such as the facial landmark 120A, the distinguishing letter “A” is used. However, when referring to any arbitrary facial landmark or to the facial landmarks as a group, the reference number 120 is used without a distinguishing letter.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

The techniques described herein improve facial exposure during an image capture by adjusting a facial region of interest that is used to determine (e.g., calculate) a facial luma of a face in a scene. In particular, the techniques described herein may be used to expand the facial region of interest of the face to include a forehead region when determining the facial luma. By expanding the facial region of interest, a more accurate facial luma may be calculated which, in turn, enables an accurate adjustment of the facial exposure. For example, to account for overhead lighting that creates reflectance on the forehead region, the techniques described herein include differently illuminated face skin regions, such as the forehead region, to confidently calculate a reliable skin luma, while excluding non-relevant face information like sunglasses, face masks, etc.

Metering is traditionally used to determine the light in the scene. Based on the light in the scene, exposure parameters (e.g., exposure settings) may be determined. Examples of metering may include center weighted metering; however, in scenes with human subjects, it may be beneficial to assign a larger metering weight to faces. For traditional portrait photography, photographers control spot metering on the skin of the subject to ensure the subject's face is properly exposed. A device may simulate traditional portrait photography by using a facial region of interest box and calculating the luma in the facial region of interest. Based on the facial region of interest luma, the device can adjust the exposure of the human subject. However, the facial region of interest box may not be entirely representative of the face illumination. For example, the facial region of interest box may exclude certain parts of the face or may include non-face pixels (e.g., pixels indicative of sunglasses). The techniques described herein improve (e.g., expand) the facial region of interest box to calculate a more accurate luma and adjust exposure parameters based on the luma.

To illustrate, exposure parameters for the face in the scene may be prioritized by (i) calculating the luma for the facial region and (ii) adjusting the exposure parameters based on an average luma value across the facial region. Typically, one or more machine learning models (herein referred to as “the machine learning model(s)”) can use image data to identify a facial region of interest that spans from the top of the eye region to the center of the mouth, skipping the forehead region. Although using the facial region of interest, spanning from the eye region to the mouth, to calculate the average luma across the facial region typically results in an adequate luma value, in some scenarios, lighting may be strong from overhead and the forehead region may be subject to a relatively large amount of light. Because the forehead region is not typically considered in the facial luma calculations, the face may become overexposed, creating unrealistic skin tones or unappealing skin texture. Thus, in many scenarios, the forehead region may be a useful region for exposure evaluation, and because the typical machine learning model only uses the region between the eyes and the mouth to calculate the facial luma, a resulting output may be subject to a brighter exposure target for the face that does not take into account the forehead region.

To improve the exposure parameters for the facial region, the techniques described herein may be used to (i) adjust (e.g., expand) the facial region of interest to include the forehead region and (ii) utilize skin pixels, as opposed to both skin pixels and non-skin pixels, within the adjusted facial region of interest to calculate the luma for the facial region. For example, image data associated with the scene, such as a streamed output of an image sensor, may be provided to machine learning model(s). Based on the image data, a face detector node of the machine learning model(s) may generate facial landmark data that is indicative of facial landmarks of the face, a segmentation node of the machine learning model(s) may generate a segmentation mask that is usable to classify pixels as skin pixels or non-skin pixels, and an initial region of interest node of the machine learning model(s) may generate an initial region of interest (e.g., a region of interest box) that spans from the mouth region to the eye region.

However, after generation of the initial region of interest, a processor may generate an adjusted region of interest by expanding the initial region of interest to include the forehead region. To illustrate, the processor may call a facial region of interest adjustment function (e.g., “AdjustFaceROI”) to generate the adjusted region of interest. Inputs to the facial region of interest adjustment function may include the facial landmarks (e.g., the left eye, the right eye, the nose, and the mouth) indicated in the facial landmark data and the initial region of interest. The facial region of interest adjustment function may identify a first axis (e.g., a major forehead axis) along facial landmarks, such as the mouth and the nose, indicated by the facial landmark data. Using the segmentation data, the facial region of interest adjustment function may search for a first axis point on the first axis that corresponds to a point on the face that is outside of the initial region of interest. In particular, the facial region of interest adjustment function may use the segmentation data to identify the skin pixel on the first axis that is farthest from the mouth. This skin pixel may represent the top of the forehead region. Thus, to find the major forehead axis, the facial region of interest adjustment function may consider the line between the nose and mouth landmarks as the major axis dividing the face. The facial region of interest adjustment function may search for the primary forehead point (e.g., the first axis point) along the major axis by binary searching for the farthest skin pixel within a reasonable forehead distance. The facial region of interest adjustment function may adjust (e.g., expand) the initial region of interest to include the first axis point (e.g., the skin pixel on the first axis that is farthest from the mouth).

In some implementations, the facial region of interest adjustment function may further adjust (e.g., expand) the region of interest to include the leftmost point of the forehead region. For example, the facial region of interest adjustment function may identify a second axis (e.g., a minor forehead axis) along facial landmarks, such as the mouth and the left eye, indicated by the facial landmark data. The facial region of interest adjustment function may use the segmentation data to identify the skin pixel (e.g., a second axis point) on the second axis that is farthest from the mouth. This skin pixel may represent the left-most point of the forehead region. The facial region of interest adjustment function may further adjust (e.g., expand) the initial region of interest to include the second axis point (e.g., the skin pixel on the second axis that is farthest from the mouth).

The facial region of interest adjustment function may further adjust (e.g., expand) the region of interest to include the right-most point of the forehead region. For example, the facial region of interest adjustment function may identify a third axis (e.g., a minor forehead axis) along facial landmarks, such as the mouth and the right eye, indicated by the facial landmark data. The facial region of interest adjustment function may use the segmentation data to identify the skin pixel (e.g., a third axis point) on the third axis that is farthest from the mouth. This skin pixel may represent the right-most point of the forehead region. The facial region of interest adjustment function may further adjust (e.g., expand) the initial region of interest to include the third axis point (e.g., the skin pixel on the second axis that is farthest from the mouth). Although the minor forehead axis are characterized by lines between the mouth and the eyes, in some implementations, a single minor forehead axis may be characterized by a line between the left and right eyes.

After the adjusted region of interest is generated (e.g., the region of interest that includes the axis points), the processor and/or the machine learning model(s) may assign weights to pixels within the adjusted region of interest based on (i) each pixel's distance from the center of the adjusted region of interest box and (ii) the probability that a pixel is a skin pixel, as opposed to a non-skin pixel. For example, the processor and/or the machine learning model(s) may use the segmentation mask (e.g., a 256×256 pixel mask) to calculate the average skin probability of the pixels within the adjusted region of interest. Three non-limiting embodiments for weighting pixels or segments are provided below.

According to a first embodiment, the adjusted region of interest may be split into segments (e.g., 16×12 pixel segments). The processor and/or the machine learning model(s) may calculate the average skin probability of each segment using the segmentation mask, and multiply its weighting by this probability. Segments that confidently and fully contain skin may be weighted fully. Segments that are not confidently skin or contain non-skin areas may be weighted less heavily.

According to a second embodiment, the machine learning model(s) may set a threshold for a minimum average skin probability. The processor and/or the machine learning model(s) may calculate the average skin probability of each segment using the segmentation mask (e.g., a 64×48 skin probability mask); however, the processor and/or the machine learning model(s) may bypass segments that are below the minimum average skin probability. Thus, segments that are not confidently classified as skin are not considered for the facial luma calculation.

According to a third embodiment, if any of the segments, from which the segmentation mask (e.g., a 256×256 skin probability mask) is applied, are below the minimum average skin probability, the processor and/or the machine learning model(s) may bypass using the segment during calculation of the facial luma. Thus, in this embodiment, a segment that includes enough non-skin pixels that reduce the skin probability of the segment below the minimum average skin probability may not be considered for the facial luma calculation. However, if the minimum average skin probability is high, segments that include mostly skin pixels and only have a small portion of non-skin pixels may also not be considered for the facial luma calculation.

After the facial luma is determined (e.g., calculated) in the adjusted region of interest, the exposure parameters may be adjusted based on the facial luma to (i) reduce the likelihood of a brighter exposure target for the face or (ii) reduce the likelihood of a darker exposure target for the face. Thus, adjusting the region of interest to include the forehead region, an improved luma may be calculated to adjust the exposure parameters. For example, because overhead lighting may create reflectance on the forehead region, the machine learning model(s) may include differently illuminated face skin regions to confidently calculate a reliable skin luma, while excluding non-relevant face information like sunglasses, face masks, or background in the region of interest.

### II. Example Process

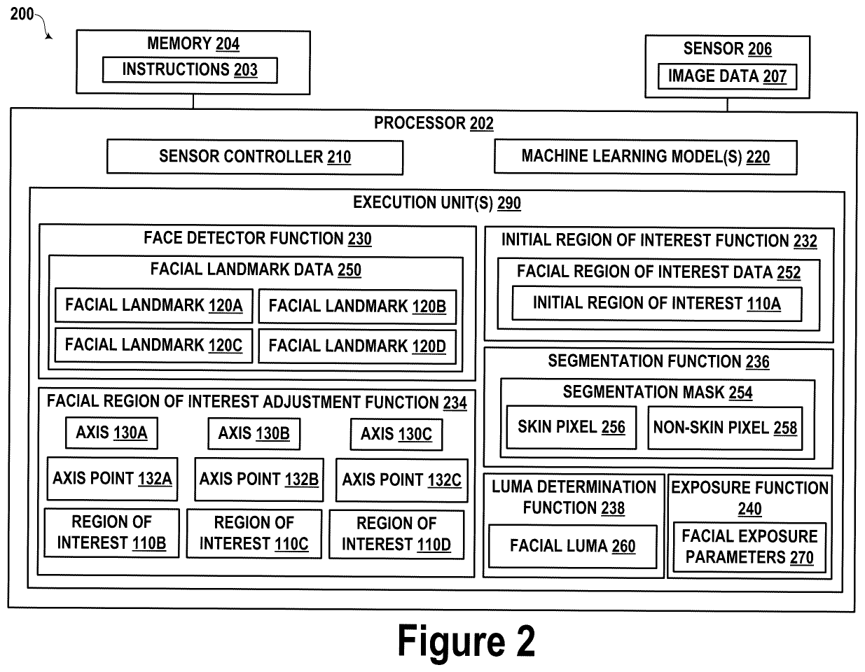

FIG. 1A illustrates a scene 100 to be captured by a sensor, such as the sensor 206 of FIG. 2. As shown in FIG. 1A, the scene 100 depicts a face 102 of a young child. Image data associated with the scene 100 may be provided to a processor, such as the processor 202 of FIG. 2. For example, the sensor 206 may be configured to generate the image data associated with the scene 100 and may provide the image data to the processor 202. In some scenarios, the image data associated with the scene 100 can be generated without capturing the scene 100. For example, light indicative of the scene 100 may enter through a lens of the sensor 206, and a signal output by the sensor 206 may be processed to generate the image data.

The processor 202 may provide the image data associated with the scene 100 to one or more machine learning models 220 (e.g., herein referred to as “the machine learning model(s) 220”). As described and illustrated with respect to FIGS. 1B-1H, the processor 202 may adjust (e.g., expand) a region of interest of the face 102 to encompass additional facial regions, such as the forehead region. Pixels, such as skin pixels, within the expanded region of interest may be used to determine (e.g., calculate) a facial luma, which in turn, may be used to improve facial exposure during an image capture.

FIG. 1B illustrates process steps for adjusting a facial region of interest to accurately calculate a facial luma. The process steps in FIG. 1B may be performed on the image data associated with the scene 100 by the processor 202.

In FIG. 1B, based on the image data associated with the scene 100, the processor 202 and/or the machine learning model(s) 220 may generate facial landmark data that is indicative of facial landmarks 120 of the face 102. For example, the processor 202 and/or the machine learning model(s) 220 may identify a facial landmark 120A, a facial landmark 120B, a facial landmark 120C, and a facial landmark 120D. As illustrated in FIG. 1B, the facial landmark 120A may correspond to a mouth on the face 102, the facial landmark 120B may correspond to a nose on the face 102, the facial landmark 120C may correspond to a first eye on the face 102, and the facial landmark 120D may correspond to a second eye on the face 102.

Additionally, based on the image data associated with the scene 100, the processor 202 and/or the machine learning model(s) 220 may generate facial region of interest data that is indicative of an initial region of interest 110A of the face 102. The initial region of interest 110A may span from the mouth region (e.g., the facial landmark 120A) to the eye region (e.g., the facial landmarks 120C, 120D) of the face 102.

FIG. 1C illustrates additional process steps for adjusting a facial region of interest to accurately calculate a facial luma. The process steps in FIG. 1C may be performed on the image data associated with the scene 100 by the processor 202.

In FIG. 1C, the processor 202 may generate an axis 130A along the facial landmark 120A and the facial landmark 120B. For example, as depicted in FIG. 1C, the axis 130A may intersect the mouth of the face 102 and the nose of the face 102. The processor 202 may also identify an axis point 132A on the axis 130A. The axis point 132A may correspond to a point on the face 102 that is outside the initial region of interest 110A. For example, the axis point 132A may be located proximate to a top of the forehead of the face 102. As described in greater detail below, to identify the axis point 132A, the processor 202 may identify, using the segmentation mask 254 of FIG. 2, a farthest skin pixel from the facial landmark 120A (e.g., the mouth) on the axis 130A. The farthest skin pixel may correspond to the axis point 132A.

FIG. 1D illustrates additional process steps for adjusting a facial region of interest to accurately calculate a facial luma. The process steps in FIG. 1D may be performed on the image data associated with the scene 100 by the processor 202.

In FIG. 1D, the processor 202 may expand the initial region of interest 110A to include the axis point 132A. Thus, by expanding the initial region of interest 110A, the processor 202 may generate an adjusted region of interest 110B that includes a forehead region of the face 102.

FIG. 1E illustrates additional process steps for adjusting a facial region of interest to accurately calculate a facial luma. The process steps in FIG. 1E may be performed on the image data associated with the scene 100 by the processor 202.

In FIG. 1E, the processor 202 may generate an axis 130B along the facial landmark 120A and the facial landmark 120C. For example, as depicted in FIG. 1E, the axis 130B may intersect the mouth of the face 102 and the first eye of the face 102. The processor 202 may also identify an axis point 132B on the axis 130B. The axis point 132B may correspond to a point on the face 102 that is outside the initial region of interest 110A (and the adjusted region of interest 110B). For example, the axis point 132B may be located proximate to a first side of the forehead of the face 102. As described in greater detail below, to identify the axis point 132B, the processor 202 may identify, using the segmentation mask 254, a farthest skin pixel from the facial landmark 120A (e.g., the mouth) on the axis 130B. The farthest skin pixel may correspond to the axis point 132B.

FIG. 1F illustrates additional process steps for adjusting a facial region of interest to accurately calculate a facial luma. The process steps in FIG. 1F may be performed on the image data associated with the scene 100 by the processor 202.

In FIG. 1F, the processor 202 may expand the initial region of interest 110A to also include the axis point 132B. Thus, by further expanding the initial region of interest 110A, the processor 202 may generate an adjusted region of interest 110C that includes additional parts of the forehead region of the face 102.

FIG. 1G illustrates additional process steps for adjusting a facial region of interest to accurately calculate a facial luma. The process steps in FIG. 1G may be performed on the image data associated with the scene 100 by the processor 202.

In FIG. 1G, the processor 202 may generate an axis 130C along the facial landmark 120A and the facial landmark 120D. For example, as depicted in FIG. 1G, the axis 130C may intersect the mouth of the face 102 and the second eye of the face 102. The processor 202 may also identify an axis point 132C on the axis 130C. The axis point 132B may correspond to a point on the face 102 that is outside the initial region of interest 110A (and the adjusted regions of interest 110B, 110C). For example, the axis point 132C may be located proximate to a second side of the forehead of the face 102. As described in greater detail below, to identify the axis point 132C, the machine learning model(s) 220 may identify, using the segmentation mask 254, a farthest skin pixel from the facial landmark 120A (e.g., the mouth) on the axis 130C. The farthest skin pixel may correspond to the axis point 132C.

FIG. 1H illustrates additional process steps for adjusting a facial region of interest to accurately calculate a facial luma. The process steps in FIG. 1H may be performed on the image data associated with the scene 100 by the processor 202.

In FIG. 1H, the processor 202 may expand the initial region of interest 110A to also include the axis point 132C. Thus, by further expanding the initial region of interest 110A, the processor 202 may generate an adjusted region of interest 110D that includes additional parts of the forehead region of the face 102.

The process described with respect to FIGS. 1A-1H improves facial exposure during an image capture by adjusting the initial facial region of interest 110A that is used to determine (e.g., calculate) a facial luma of the face 102 in the scene 100. In particular, the process expands the initial facial region of interest 110A of the face 102 to include a forehead region when determining the facial luma. By expanding the initial facial region of interest 110A, a more accurate facial luma may be calculated which, in turn, enables an accurate adjustment of the facial exposure.

### III. Example Device

FIG. 2 illustrates a diagram of a device 200, in accordance with examples described herein. The device 200 may be configured to adjust (e.g., expand) a facial region of interest that is used to determine (e.g., calculate) a facial luma 260 of the face 102 in the scene 100.

The device 200 includes a processor 202 and a memory 204 coupled to the processor 202. The memory 204 can be a non-transitory computer-readable medium that stores instructions 203 that are executable by the processor 202 to perform the operations described herein. Specifically, the instructions 203 can be executable to cause the processor 202 to adjust (e.g., expand) a facial region of interest that is used to calculate the facial luma 260 of the face 102 in the scene 100. In some embodiments, the instructions 203 may be computer-executable program instructions embodied on a non-transitory computer-readable storage device, such as a memory or a computer program product.

The device 200 also includes a sensor 206 coupled to the processor 202. The sensor 206 may be configured to generate image data 207 associated with the scene 100 and may provide the image data 207 to the processor 202. In some scenarios, the image data 207 associated with the scene 100 can be generated without capturing the scene 100. For example, light indicative of the scene 100 may enter through a lens of the sensor 206, and a signal output by the sensor 206 may be processed to generate the image data 207.

It should be understood that additional components (e.g., circuitry, hardware, etc.) can be coupled to the processor 202. As non-limiting examples, a display screen can be coupled to the processor 202, a transceiver can be coupled to the processor 202, an auxiliary device interface can be coupled to the processor 202, one or more additional sensors can be coupled to the processor 202, etc. The components depicted in FIG. 2 are merely for illustrative purposes and should not be construed as limiting.

The processor 202 includes a sensor controller 210. The sensor controller 210 controller 210 can be configured to control operation of the sensor 206. For example, the sensor controller 210 may set exposure parameters for the sensor 206, an aperture for sensor 206, a shutter speed of the sensor 206, etc. The processor 202 may also include other components not depicted in FIG. 2. As non-limiting examples, the processor 202 may include a display controller, a network monitor, etc. According to some implementations, one or more components of the processor 202 can be implemented using dedicated circuitry. As non-limiting examples, one or more components of the processor 202 can be implemented using application-specific integrated circuits (ASICs) or field-programmable gate array (FPGA) devices. According to some implementations, one or more components of the processor 202 can be implemented using software. As a non-limiting example, the processor 202 can execute the instructions 203 stored in the memory 204 to perform the operations of one or more components of the processor 202.

One or more execution units 290 (herein referred to as “the execution unit(s) 290”) can be integrated into the processor 202 to perform one or more operations associated with adjusting (e.g., expanding) a facial region of interest that is used to determine (e.g., calculate) a facial luma 260 of the face 102 in the scene 100. Although adjustment of the facial region of interest, determination of the facial luma 260, and adjustment of the facial exposure parameters 270 are described as being performed the execution unit(s) 290, in some embodiments, the processor 202 may use the machine-learning model(s) 220 to perform one or more operations to adjust the facial region of interest, determine the facial luma 260, and/or adjust the facial exposure parameters 270.

Based on the image data 207, the execution unit(s) 290 may utilize a face detector function 230 of the machine learning model(s) 220 to generate facial landmark data 250 that is indicative of the facial landmarks 120 of the face 102. For example, the facial detector function 230 may be used to identify the facial landmark 120A, the facial landmark 120B, the facial landmark 120C, and the facial landmark 120D. As illustrated in FIG. 1B, the facial landmark 120A may correspond to a mouth on the face 102, the facial landmark 120B may correspond to a nose on the face 102, the facial landmark 120C may correspond to a first eye on the face 102, and the facial landmark 120D may correspond to a second eye on the face 102.

Based on the image data 207, the execution unit(s) 290 may utilize an initial region of interest function 232 of the machine learning model(s) 220 to generate facial region of interest data 252 that is indicative of the initial region of interest 110A of the face 102. The initial region of interest 110A may span from the mouth region (e.g., the facial landmark 120A) to the eye region (e.g., the facial landmarks 120C, 120D) of the face 102.

To adjust (e.g., expand) the initial region of interest 110A, the execution unit(s) 290 may utilize a facial region of interest adjustment function 234 of the machine learning model(s) 220 to generate the axis 130A along the facial landmark 120A and the facial landmark 120B. For example, as depicted in FIG. 1C, the axis 130A may intersect the mouth of the face 102 and the nose of the face 102. The facial region of interest adjustment function 234 may also be used to identify an axis point 132A on the axis 130A. The axis point 132A may correspond to a point on the face 102 that is outside the initial region of interest 110A. For example, the axis point 132A may be located proximate to a top of the forehead of the face 102.

To identify the axis point 132A, the execution unit(s) 290 may utilize a segmentation function 236 of the machine learning model(s) 220 to generate a segmentation mask 254 that is usable to classify pixels (or segments) as skin pixels 256 or non-skin pixels 258. Thus, the segmentation mask 254 may be used to identify the farthest skin pixel 256 (e.g., the axis point 132A) from the facial landmark 120A (e.g., the mouth) on the axis 130A.

The facial region of interest adjustment function 234 may be used to expand the initial region of interest 110A to include the axis point 132A. Thus, by expanding the initial region of interest 110A, the facial region of interest adjustment function 234 may be used to generate the adjusted region of interest 110B that includes a forehead region of the face 102.

To further adjust the initial region of interest 110A, the facial region of interest adjustment function 234 may be used (e.g., executed by the execution unit(s) 290) to generate the axis 130B along the facial landmark 120A and the facial landmark 120C. For example, as depicted in FIG. 1E, the axis 130B may intersect the mouth of the face 102 and the first eye of the face 102. The facial region of interest adjustment function 234 may also be used to identify the axis point 132B on the axis 130B using the segmentation mask 254. The axis point 132B may correspond to a point on the face 102 that is outside the initial region of interest 110A (and the adjusted region of interest 110B). For example, the axis point 132B may be located proximate to a first side of the forehead of the face 102.

The facial region of interest adjustment function 234 may be used to expand the initial region of interest 110A to also include the axis point 132B. Thus, by further expanding the initial region of interest 110A, the facial region of interest adjustment function 234 may be used to generate the adjusted region of interest 110C that includes additional parts of the forehead region of the face 102.

To further adjust the initial region of interest 110A, the facial region of interest adjustment function 234 may be used to generate the axis 130C along the facial landmark 120A and the facial landmark 120D. For example, as depicted in FIG. 1G, the axis 130C may intersect the mouth of the face 102 and the second eye of the face 102. The facial region of interest adjustment function 234 may also be used to identify the axis point 132C on the axis 130C using the segmentation mask 254. The axis point 132B may correspond to a point on the face 102 that is outside the initial region of interest 110A (and the adjusted regions of interest 110B, 110C). For example, the axis point 132C may be located proximate to a second side of the forehead of the face 102.

The facial region of interest adjustment function 234 may be used to expand the initial region of interest 110A to also include the axis point 132C. Thus, by further expanding the initial region of interest 110A, the facial region of interest adjustment function 234 may be used to generate an adjusted region of interest 110D that includes additional parts of the forehead region of the face 102.

After the adjusted region of interest 110D is generated, the execution unit(s) 290 may utilize the luma determination function 238 of the machine learning model(s) 220 to determine the facial luma 260 based at least in part on pixel values in the adjusted region of interest 110D. However, in some scenarios, some of the pixels within the adjusted region of interest 110D may be classified as non-skin pixels 258, as opposed to skin pixels 256. As non-limiting examples, if there are sunglasses within the adjusted region of interest 110D, hair within the adjusted region of interest 110D, and/or an environmental background within the adjusted region of interest 110D, the associated pixels may be non-skin pixels 258.

To ensure that skin pixels 264 (e.g., pixels representative of the face 102) are properly weighted when determining the facial luma 260, the machine learning model(s) 220 may assign a weighting value to each pixel (or to segments of pixels) within the adjusted region of interest 110D using the segmentation mask 254. The luma determination function 238 may be used to determine the facial luma 260 based on a weighted average of the pixel values (or segment values) in the adjusted region of interest 110D.

According to a first embodiment, the segmentation function 236 may be used to split the adjusted region of interest 110D into segments (e.g., 64×48 pixel segments). The processor 202 may calculate the average skin probability of each segment (e.g., the probability that the 64×48 pixel segments are associated with skin pixels 256) using the segmentation mask 254, and multiply the segment's weighting by this probability. Segments that confidently and fully contain skin pixels 256 may be weighted fully when determining the facial luma 260. Segments that do not confidently and fully contain skin pixels 256 (e.g., segments that may contain non-skin pixels 258) may be weighted less heavily when determining the facial luma 260.

According to a second embodiment, the processor 202 may set a threshold for a minimum average skin probability. The machine learning model(s) 220 may calculate the average skin probability of each segment using the segmentation mask 254; however, the machine learning model(s) 220 may bypass segments that are below the minimum average skin probability. Thus, segments that do not confidently contain skin pixels 256 are not considered when determining the facial luma 260.

According to a third embodiment, if any of the segments, from which the segmentation mask 254 is applied, are below the minimum average skin probability, the processor 202 may weigh the segment at zero (0). Thus, in this embodiment, a segment that includes non-skin pixel 258 may not be considered when determining the facial luma 260; however, segments that include mostly skin pixels 256 and only have a small portion of non-skin pixels 258 may also not be considered when determining the facial luma 260.

After the facial luma 260 is determined, the exposure function 240 may be used to adjust one or more facial exposure parameters 270 based on the facial luma 260. The sensor controller 210 may send the adjusted facial exposure parameters 270 to the sensor 206 and initiate capture of the scene 100 based on the adjusted facial exposure parameters 270.

The device 200 of FIG. 2 improves facial exposure during an image capture by adjusting the initial facial region of interest 110A that is used to determine (e.g., calculate) the facial luma 260 of the face 102 in the scene 100. In particular, the device 200 expands the initial facial region of interest 110A of the face 102 to include a forehead region when determining the facial luma 260. By expanding the initial facial region of interest 110A, a more accurate facial luma 260 may be calculated which, in turn, enables an accurate adjustment of the facial exposure (e.g., enables accurate adjustment of the facial exposure parameters 270).

### Iv. Example Process of Adjusting a Region of Interest

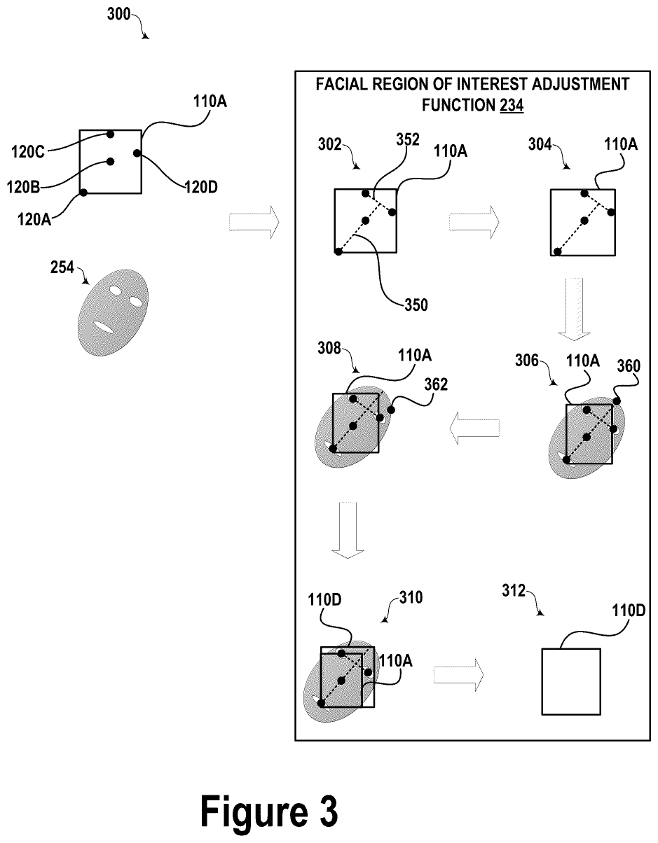

FIG. 3 illustrates an example of a process 300 of adjusting a region of interest, in accordance with examples described herein. The process 300 may be performed by the processor 202 of FIG. 2. In particular, the process 300 may be performed by executing the facial region of interest adjustment function 234.

According to the process 300, the initial region of interest 110A, the facial landmarks 120A-120D, and the segmentation mask 254 may be provided as inputs to the facial region of interest adjustment function 234.

At process step 302, a first line 350 between the facial landmark 120A (e.g., the mouth) and the facial landmark 120B (e.g., the nose) may be computed using the facial region of interest adjustment function 234. Additionally, at process step 302, a second line 352 between the facial landmark 120C (e.g., the first eye) and the facial landmark 120D (e.g., the second eye) may be computed using the facial region of interest adjustment function 234.

At process step 304, the facial region of interest adjustment function 234 may compute an intersection between the first line 350 and the second line 352.

At process step 306, the facial region of interest adjustment function 234 may find a primary point 360 within the skin region of the segmentation mask 254 along the major nose-mouth axis (e.g., along the axis 130A). In particular, the facial region of interest adjustment function 234 may perform a binary search for a top forehead point.

At process step 308, the facial region of interest adjustment function 234 may find a neighboring secondary point 362 within the skin region of the segmentation mask 254 along a minor axis (e.g., along the axis 130B or the axis 130C). In particular, the facial region of interest adjustment function 234 may perform a binary search for a side forehead point.

At process step 310, the facial region of interest adjustment function 234 may adjust the initial region of interest 110A to include the points 360, 362. In particular, the facial region of interest adjustment function 234 may expand the initial region of interest 110A to include the top forehead point 360 and the side forehead point 362.

At process step 312, the facial region of interest adjustment function 234 may output the adjusted region of interest 110D.

### V. Example Machine Learning Process

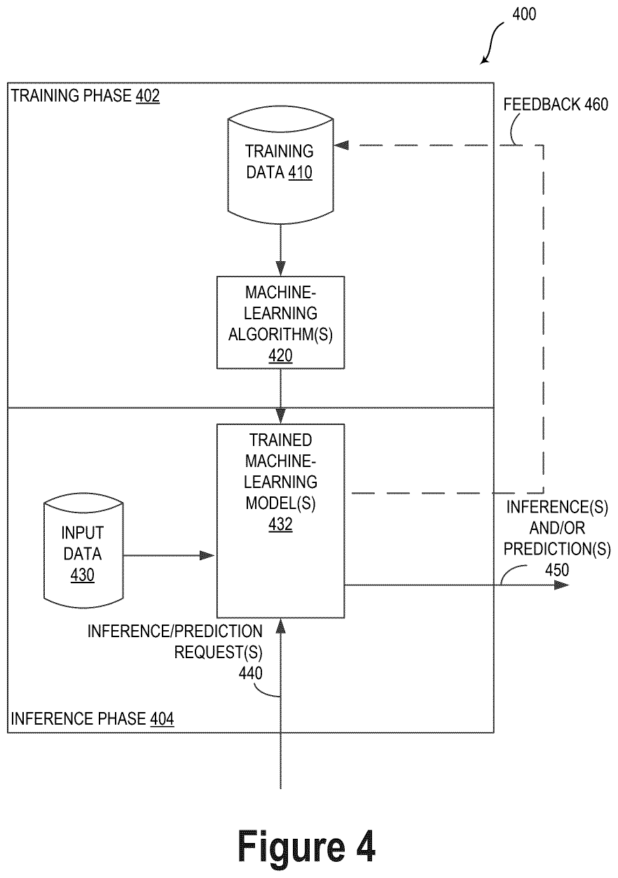

FIG. 4 shows a diagram 400 illustrating a training phase 402 and an inference phase 404 of trained machine learning model(s) 432, in accordance with example embodiments. According to some examples, the trained machine learning model(s) 432 can correspond to the machine learning model(s) 220. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 4 shows the training phase 402 where machine learning algorithm(s) 420 are being trained on training data 410 to become trained machine learning model(s) 432. Then, during the inference phase 404, the trained machine learning model(s) 432 can receive input data 430 and one or more inference/prediction requests 440 (perhaps as part of the input data 430) and responsively provide as an output one or more inferences and/or prediction(s) 450.

As such, the trained machine learning model(s) 432 can include one or more models of machine learning algorithm(s) 420. The machine learning algorithm(s) 420 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). The machine learning algorithm(s) 420 may be supervised or unsupervised, and may implement any suitable combination of online and offline learning.

In some examples, the machine learning algorithm(s) 420 and/or the trained machine learning model(s) 432 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up the machine learning algorithm(s) 420 and/or the trained machine learning model(s) 432. In some examples, the trained machine learning model(s) 432 can be trained, resided and executed to provide inferences on a particular computing device, and/or otherwise can make inferences for the particular computing device.

During the training phase 402, the machine learning algorithm(s) 420 can be trained by providing at least the training data 410 as training input using unsupervised, supervised, semi-supervised, and/or reinforcement learning techniques. Unsupervised learning involves providing a portion (or all) of the training data 410 to the machine learning algorithm(s) 420 and the machine learning algorithm(s) 420 determining one or more output inferences based on the provided portion (or all) of the training data 410. Supervised learning involves providing a portion of the training data 410 to the machine learning algorithm(s) 420, with the machine learning algorithm(s) 420 determining one or more output inferences based on the provided portion of the training data 410, and the output inference(s) are either accepted or corrected based on correct results associated with the training data 410. In some examples, supervised learning of the machine learning algorithm(s) 420 can be governed by a set of rules and/or a set of labels for the training input, and the set of rules and/or set of labels may be used to correct inferences of the machine learning algorithm(s) 420.

Semi-supervised learning involves having correct results for part, but not all, of the training data 410. During semi-supervised learning, supervised learning is used for a portion of the training data 410 having correct results, and unsupervised learning is used for a portion of the training data 410 not having correct results. Reinforcement learning involves the machine learning algorithm(s) 420 receiving a reward signal regarding a prior inference, where the reward signal can be a numerical value. During reinforcement learning, the machine learning algorithm(s) 420 can output an inference and receive a reward signal in response, where the machine learning algorithm(s) 420 are configured to try to maximize the numerical value of the reward signal. In some examples, reinforcement learning also utilizes a value function that provides a numerical value representing an expected total of the numerical values provided by the reward signal over time. In some examples, the machine learning algorithm(s) 420 and/or the trained machine learning model(s) 432 can be trained using other machine learning techniques, including but not limited to, incremental learning and curriculum learning.

In some examples, the machine learning algorithm(s) 420 and/or the trained machine learning model(s) 432 can use transfer learning techniques. For example, transfer learning techniques can involve the trained machine learning model(s) 432 being pre-trained on one set of data and additionally trained using the training data 410. More particularly, the machine learning algorithm(s) 420 can be pre-trained on data from one or more computing devices and a resulting trained machine learning model provided to a particular computing device, where the particular computing device is intended to execute the trained machine learning model during the inference phase 404. Then, during the training phase 402, the pre-trained machine learning model can be additionally trained using the training data 410, where the training data 410 can be derived from kernel and non-kernel data of the particular computing device. This further training of the machine learning algorithm(s) 420 and/or the pre-trained machine learning model using the training data 410 of the particular computing device's data can be performed using either supervised or unsupervised learning. Once the machine learning algorithm(s) 420 and/or the pre-trained machine learning model has been trained on at least the training data 410, the training phase 402 can be completed. The trained resulting machine learning model can be utilized as at least one of the trained machine learning model(s) 432.

In particular, once the training phase 402 has been completed, the trained machine learning model(s) 432 can be provided to a computing device, if not already on the computing device. The inference phase 404 can begin after training the machine learning model(s) 432 are provided to the particular computing device.

During the inference phase 404, the trained machine learning model(s) 432 can receive the input data 430 and generate and output one or more corresponding inferences and/or prediction(s) 450 about the input data 430. As such, the input data 430 can be used as an input to the trained machine learning model(s) 432 for providing corresponding inference(s) and/or prediction(s) 450 to kernel components and non-kernel components. For example, the trained machine learning model(s) 432 can generate inference(s) and/or prediction(s) 450 in response to one or more inference/prediction requests 440. In some examples, the trained machine learning model(s) 432 can be executed by a portion of other software. For example, the trained machine learning model(s) 432 can be executed by an inference or prediction daemon to be readily available to provide inferences and/or predictions upon request. The input data 430 can include data from the particular computing device executing the trained machine learning model(s) 432 and/or input data from one or more computing devices other than the particular computing device.

If the trained machine learning model 432 corresponds to the machine learning model(s) 220, the input data 430 can include the image data 207. Other types of input data are possible as well. Inference(s) and/or prediction(s) 450 can include other output data produced by the trained machine learning model(s) 432 operating on the input data 430 (and the training data 410). In some examples, the trained machine learning model(s) 432 can use output inference(s) and/or prediction(s) 450 as input feedback 460. The trained machine learning model(s) 432 can also rely on past inferences as inputs for generating new inferences.

Convolutional neural networks and/or deep neural networks used herein can be an example of the machine learning algorithm(s) 420. After training, the trained version of a convolutional neural network can be an example of the trained machine learning model(s) 432.

### VI. Additional Example Operations

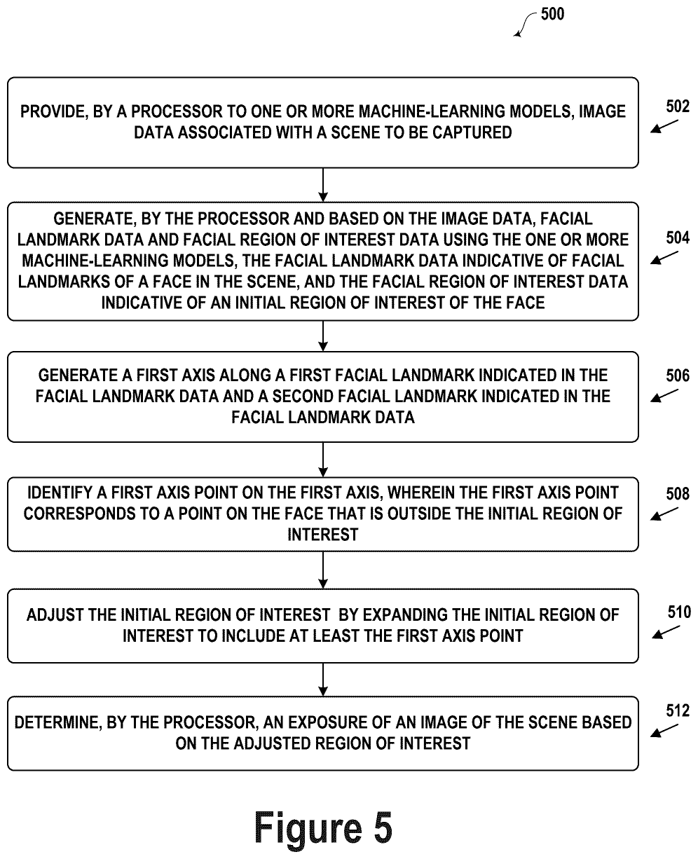

FIG. 5 illustrates a flow chart of a method 500 related to a new technology. The method 500 may be carried out by the device 200 among other possibilities. The embodiments of FIG. 5 may be simplified by the removal of any one or more of the features shown therein. Further, these embodiments may be combined with features, aspects, and/or implementations of any of the previous figures or otherwise described herein.

The method 500 includes providing, by a processor to one or more machine learning models, image data associated with a scene to be captured, at block 502. For example, referring to FIGS. 1A and 2, the processor 202 provides the image data 207 associated with the scene 100 to the machine learning model(s) 220.

The method 500 also includes generating, by the processor and based on the image data, facial landmark data and facial region of interest data using the one or more machine learning models, at block 504. The facial landmark data is indicative of facial landmarks of a face in the scene, and the facial region of interest data is indicative of an initial region of interest of the face. For example, referring to FIGS. 1B and 2, the processor 202 generates the facial landmark data 250 and the facial region of interest data 252 using the machine learning model(s) 220. The facial landmark data 250 is indicative of the facial landmarks 120A-120D on the face 102 in the scene 100, and the facial region of interest data 252 is indicative of the initial region of interest 110A of the face 102.

The method 500 also includes generating a first axis along a first facial landmark indicated in the facial landmark data and a second facial landmark indicated in the facial landmark data, at block 506. For example, referring to FIGS. 1C and 2, the processor 202 generates the axis 130A along the facial landmark 120A and the facial landmark 120B.

The method 500 also includes identifying a first axis point on the first axis, at block 508. The first axis point corresponds to a point on the face that is outside the initial region of interest. For example, referring to FIGS. 1C and 2, the processor 202 identifies the axis point 132A on the axis 130A. The axis point 132A corresponds to a point or pixel on the face 102 that is outside the initial region of interest 110A. According to one implementation of the method 500, the first axis point is located proximate to a top of a forehead. For example, referring to FIG. 1C, the axis point 132A is located proximate to the top of the forehead.

The method 500 also includes adjusting the initial region of interest by expanding the initial region of interest to include at least the first axis point, at block 510. For example, referring to FIGS. 1D and 2, the processor 202 adjusts the initial region of interest 110A by expanding the initial region of interest 110A to include the axis point 132A.

The method 500 also includes determining, by the processor, an exposure of an image of the scene based on the adjusted region of interest, at block 512. For example, the processor 202 determines exposure parameters 270 based on the adjusted region of interest 110D.

According to one implementation of the method 500, the first facial landmark corresponds to a mouth on the face, and the second facial landmark corresponds to a nose on the face. For example, referring to FIG. 1B, the facial landmark 120A corresponds to the mouth on the face 102, and the facial landmark 120B corresponds to the nose on the face 102.

According to one implementation of the method 500, generating the adjusted region of interest further includes generating a second axis along the first facial landmark and a third facial landmark in the facial landmark data. For example, referring to FIGS. 1E and 2, the processor 202 generates the axis 130B along the facial landmark 120A and the facial landmark 120C. Generating the adjusted region of interest may also include identifying a second axis point on the second axis. The second axis point corresponds to a point on the face that is outside the initial region of interest. For example, referring to FIGS. 1E and 2, the processor 202 identifies the axis point 132B on the axis 130B. The axis point 132B corresponds to a point on the face 102 that is outside the initial region of interest 110A. Generating the adjusted region of interest may also include expanding the initial region of interest to include the second axis point. For example, referring to FIGS. 1F and 2, the processor 202 expands the initial region of interest 110A to include the axis point 132B. According to one implementation of the method 500, the second axis point is located proximate to a first side of the forehead.

According to one implementation of the method 500, generating the adjusted region of interest further includes generating a third axis along the first facial landmark and a fourth facial landmark in the facial landmark data. For example, referring to FIGS. 1G and 2, the processor 202 generates the axis 130C along the facial landmark 120A and the facial landmark 120D. Generating the adjusted region of interest may also include identifying a third axis point on the third axis. The third axis point corresponds to a point on the face that is outside the initial region of interest. For example, referring to FIGS. 1G and 2, the processor 202 identifies the axis point 132C on the axis 130C. The axis point 132C corresponds to a point on the face 102 that is outside the initial region of interest 110A. Generating the adjusted region of interest may also include expanding the initial region of interest to include the third axis point. For example, referring to FIGS. 1H and 2, the processor 202 expands the initial region of interest 110A to include the axis point 132C. According to one implementation of the method 500, the third axis point is located proximate to a second side of the forehead.

According to one implementation of the method 500, the third facial landmark corresponds to a first eye on the face, and the fourth facial landmark corresponds to a second eye on the face. For example, referring to FIG. 1B, the facial landmark 120C corresponds to the first eye on the face 102, and the facial landmark 120D corresponds to the second eye on the face 102.

According to one implementation, the method 500 may also include generating, by the processor and based on the image data, a segmentation mask using the one or more machine learning models. The segmentation mask is usable to classify pixels as skin pixels or non-skin pixels. For example, referring to FIG. 2, the processor 202 generates the segmentation mask 254 using the machine learning model(s) 220. The segmentation mask 254 is usable to classify pixels as skin pixels 256 or non-skin pixels 258.

According to one implementation, the method 500 may also include determining a luma for the face based on the adjusted region of interest. The exposure of the image is based on the luma. For example, referring to FIG. 2, the processor 202 determines the facial luma 260. The processor 202 also determines the facial exposure parameters 270 based on the facial luma 260.

According to one implementation of the method 500, determining the luma for the face includes assigning a weighting value to each pixel within the adjusted region of interest using the segmentation mask. Skin pixels may be assigned heavier weighting values than non-skin pixels. The luma may be determined based on a weighted average of the pixel values in the adjusted region of interest. The weighted average may be based on the weighting values assigned to each pixel with the adjusted region of interest.

According to one implementation of the method 500, determining the luma for the face includes segmenting the adjusted region of interest into a plurality of segments. Determining the luma may also include determining, for each segment of the plurality of segments based on pixel values in the corresponding segment, a probability of whether the segment corresponds to a skin segment. Determining the luma may also include assigning a full weighting value to skin segments. The luma may be determined based on a weighted average of the segments.

According to one implementation of the method 500, determining the luma for the face includes segmenting the adjusted region of interest into a plurality of segments. Determining the luma may also include determining, for each segment of the plurality of segments based on pixel values in the corresponding segment, a probability of whether the segment corresponds to a skin segment. The luma may be determined based on segments having a probability that satisfies a threshold.

According to one implementation, the method 500 may include segmenting the adjusted region of interest into a plurality of segments. The method 500 may also include determining, for each segment of the plurality of segments based on pixel values in the corresponding segment, a probability of whether the segment corresponds to a skin segment. The method 500 may also include bypassing determining the luma based on segments having a probability that fails to satisfy a threshold.

According to one implementation of the method 500, identifying the first axis point on the first axis may include identifying, using the segmentation mask, a farthest skin pixel from the first facial landmark on the first axis. The farthest skin pixel may correspond to the first axis point.

According to one implementation, the method 500 may include adjusting, by the processor, an auto-exposure parameter based on the luma for the face. The method 500 may also include initiating, by the processor, capture of the scene based on the adjusted auto-exposure parameter.

The method 500 of FIG. 5 improves facial exposure during an image capture by adjusting the initial facial region of interest 110A that is used to determine (e.g., calculate) the facial luma 260 of the face 102 in the scene 100. In particular, the device 200 expands the initial facial region of interest 110A of the face 102 to include a forehead region when determining the facial luma 260. By expanding the initial facial region of interest 110A, a more accurate facial luma 260 may be calculated which, in turn, enables an accurate adjustment of the facial exposure (e.g., enables accurate adjustment of the facial exposure parameters 270).

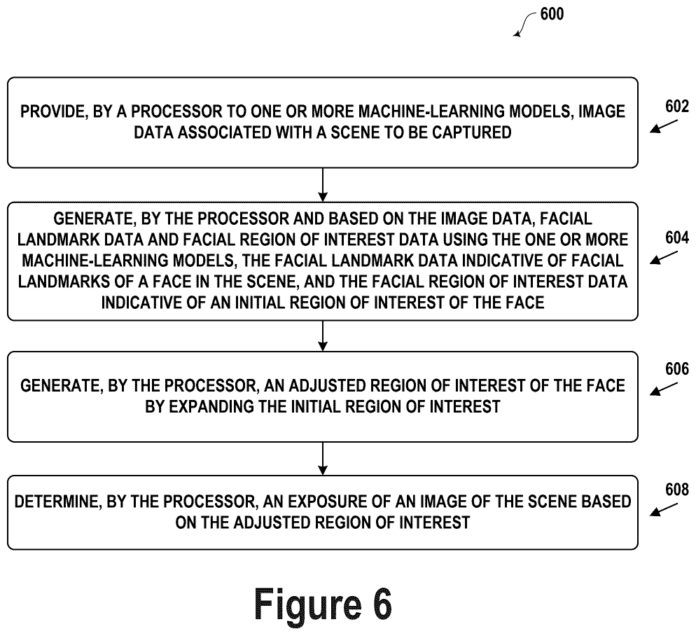

FIG. 6 illustrates a flow chart of a method 600 related to a new technology. The method 600 may be carried out by the device 200 among other possibilities. The embodiments of FIG. 6 may be simplified by the removal of any one or more of the features shown therein. Further, these embodiments may be combined with features, aspects, and/or implementations of any of the previous figures or otherwise described herein.

The method 600 includes providing, by a processor to one or more machine learning models, image data associated with a scene to be captured, at block 602. For example, referring to FIGS. 1A and 2, the processor 202 provides the image data 207 associated with the scene 100 to the machine learning model(s) 220.

The method 600 also includes generating, by the processor and based on the image data, facial landmark data and facial region of interest data using the one or more machine learning models, at block 604. The facial landmark data is indicative of facial landmarks of a face in the scene, and the facial region of interest data is indicative of an initial region of interest of the face. For example, referring to FIGS. 1B and 2, the processor 202 generates the facial landmark data 250 and the facial region of interest data 252 using the machine learning model(s) 220. The facial landmark data 250 is indicative of the facial landmarks 120A-120D on the face 102 in the scene 100, and the facial region of interest data 252 is indicative of the initial region of interest 110A of the face 102.

The method 600 also includes generating, by the processor, an adjusted region of interest of the face by expanding the initial region of interest, at block 606. In some embodiments, to generate the adjusted region of interest, the initial region of interest may be expanded to include a first axis point on a first axis. The first axis is along a first facial landmark indicated in the facial landmark data and a second facial landmark indicated in the facial landmark data.

The method 600 also includes determining, by the processor, an exposure of an image of the scene based on the adjusted region of interest, at block 608. For example, the processor 202 determines exposure parameters 270 based on the adjusted region of interest 110D.

The method 600 of FIG. 6 improves facial exposure during an image capture by adjusting the initial facial region of interest 110A that is used to determine (e.g., calculate) the facial luma 260 of the face 102 in the scene 100. In particular, the device 200 expands the initial facial region of interest 110A of the face 102 to include a forehead region when determining the facial luma 260. By expanding the initial facial region of interest 110A, a more accurate facial luma 260 may be calculated which, in turn, enables an accurate adjustment of the facial exposure (e.g., enables accurate adjustment of the facial exposure parameters 270).

### VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method comprising:
providing, by a processor to one or more machine learning models, image data associated with a scene to be captured;
generating, by the processor and based on the image data, facial landmark data and facial region of interest data using the one or more machine learning models, the facial landmark data indicative of facial landmarks of a face in the scene, and the facial region of interest data indicative of an initial region of interest of the face;
generating, by the processor, an adjusted region of interest of the face by expanding the initial region of interest; and
determining, by the processor, an exposure of an image of the scene based on the adjusted region of interest.

2. The method of claim 1, wherein, to generate the adjusted region of interest, the initial region of interest is expanded to include a first axis point on a first axis, wherein the first axis is along a first facial landmark indicated in the facial landmark data and a second facial landmark indicated in the facial landmark data.

3. The method of claim 2, wherein the first facial landmark corresponds to a mouth on the face, and wherein the second facial landmark corresponds to a nose on the face.

4. The method of claim 2, wherein the first axis point is located proximate to a top of a forehead.

5. The method of claim 2, wherein generating the adjusted region of interest further comprises expanding the initial region of interest to include a second axis point on a second axis, wherein the second axis is along the first facial landmark and a third facial landmark in the facial landmark data.

6. The method of claim 5, wherein generating the adjusted region of interest further comprises expanding the initial region of interest to include a third axis point on a third axis, wherein the third axis is along the first facial landmark and a fourth facial landmark in the facial landmark data.

7. The method of claim 6, wherein the third facial landmark corresponds to a first eye on the face, and wherein the fourth facial landmark corresponds to a second eye on the face.

8. The method of claim 6, wherein the second axis point is located proximate to a first side of a forehead, and wherein the third axis point is located proximate to a second side of the forehead.

9. The method of claim 1, further comprising determining a luma for the face based on the adjusted region of interest, wherein the exposure of the image is based on the luma.

10. The method of claim 9, further comprising generating, by the processor and based on the image data, a segmentation mask using the one or more machine learning models, wherein the segmentation mask is usable to classify pixels as skin pixels or non-skin pixels.

11. The method of claim 10, wherein determining the luma for the face comprises:
assigning a weighting value to each pixel within the adjusted region of interest using the segmentation mask, wherein skin pixels are assigned heavier weighting values than non-skin pixels,
wherein the luma is determined based on a weighted average of the pixel values in the adjusted region of interest, wherein the weighted average is based on the weighting values assigned to each pixel within the adjusted region of interest.

12. The method of claim 10, wherein determining the luma for the face comprises:
segmenting the adjusted region of interest into a plurality of segments;
determining, for each segment of the plurality of segments based on pixel values in the corresponding segment, a probability of whether the segment corresponds to a skin segment; and
assigning a full weighting value to skin segments,
wherein the luma is determined based on a weighted average of the segments.

13. The method of claim 10, wherein determining the luma for the face comprises:
segmenting the adjusted region of interest into a plurality of segments; and
determining, for each segment of the plurality of segments based on pixel values in the corresponding segment, a probability of whether the segment corresponds to a skin segment,
wherein the luma is determined based on segments having a probability that satisfies a threshold.

14. The method of claim 10, further comprising:
segmenting the adjusted region of interest into a plurality of segments;
determining, for each segment of the plurality of segments based on pixel values in the corresponding segment, a probability of whether the segment corresponds to a skin segment; and
bypassing determining the luma based on segments having a probability that fails to satisfy a threshold.

15. The method of claim 10, further comprising identifying a first axis point on a first axis by:
identifying, using the segmentation mask, a farthest skin pixel from the first facial landmark on the first axis,
wherein the farthest skin pixel corresponds to the first axis point.

16. The method of claim 1, further comprising:
initiating, by the processor, capture of the scene based on the exposure.

17. A device comprising:
a memory; and
a processor coupled to the memory, the processor configured to:
provide, to one or more machine learning models, image data associated with a scene to be captured;
generate, based on the image data, facial landmark data and facial region of interest data using the one or more machine learning models, the facial landmark data indicative of facial landmarks of a face in the scene, and the facial region of interest data indicative of an initial region of interest of the face;
generate an adjusted region of interest of the face by expanding the initial region of interest to include a first axis point on a first axis, wherein the first axis is along a first facial landmark indicated in the facial landmark data and a second facial landmark indicated in the facial landmark data; and
determine an exposure of an image of the scene based on the adjusted region of interest.

18. The device of claim 17, wherein, to generate the adjusted region of interest, the initial region of interest is expanded to include a first axis point on a first axis, wherein the first axis is along a first facial landmark indicated in the facial landmark data and a second facial landmark indicated in the facial landmark data.

19. The device of claim 18, wherein the first facial landmark corresponds to a mouth on the face, wherein the second facial landmark corresponds to a nose on the face, and wherein the first axis point is located proximate to a top of a forehead.

20. A non-transitory computer-readable medium comprising instructions that, when executed by a processor, cause the processor to perform operations comprising:
providing, to one or more machine learning models, image data associated with a scene to be captured;
generating, based on the image data, facial landmark data and facial region of interest data using the one or more machine learning models, the facial landmark data indicative of facial landmarks of a face in the scene, and the facial region of interest data indicative of an initial region of interest of the face;
generating, an adjusted region of interest of the face by expanding the initial region of interest to include a first axis point on a first axis, wherein the first axis is along a first facial landmark indicated in the facial landmark data and a second facial landmark indicated in the facial landmark data; and
determining an exposure of an image of the scene based on the adjusted region of interest.
